(19) United States
(12) Patent Application Publication
(10) Pub. No.: US 2024/0199383 A1
(43) Pub. Date: Jun. 20, 2024

(54) LIFTING MEANS FOR LIFTING A COMPONENT OF A WIND TURBINE

(71) Applicant: Wobben Properties GmbH, Aurich (DE)

(72) Inventors: Szymon Migas, Opole (PL); Dirk Ressel, Aurich (DE); Burkhard Rösingh, Jemgum (DE)

(21) Appl. No.: 18/544,219

(22) Filed: Dec. 18, 2023

(30) Foreign Application Priority Data
Dec. 19, 2022 (EP) 22214546.8

(51) Int. Cl. B66C 1/10

(52) U.S. Cl. CPC B66C 1/108

(57) ABSTRACT

A wind turbine component lifting system for lifting a component of a wind turbine includes a main body with a first and second end, as well as a respective first fastening section for accommodating screws in the area of the first and second ends, wherein the first fastening section has an oblong hole along a longitudinal direction of the main body. The lifting system has a floor plate unit, which has a floor plate with a borehole for accommodating at least one rod, screw, or a bolt. The borehole can be moved transverse to the longitudinal direction.

### BACKGROUND

### Technical Field

Embodiments of the invention relate to a lifting device for lifting a component of a wind turbine.

### Description of the Related Art

In order to build wind turbines, the components of the wind turbines must be transported and lifted. In particular the tower of the wind turbine consists of several segments, which are lifted and mounted with lifting means.

The lifting means can be fastened to the flanges on the tower segment in a specific position via screw connections. For this purpose, the holes for the screw connection in the lifting means are arranged in such a way as to correspond to a distance between the holes in the flanges of the tower segment.

The problem here is that such a lifting means can only be used for a very specific component of the wind turbine. A component with a slightly deviating distance between the holes or a different diameter and a deviating arrangement of holes associated therewith could not connected with this lifting means.

Another problem with conventional lifting means lies in the fact that the weight of the tower segment to be lifted exerts enormous forces on the lifting means. If the lifting means is not mounted properly, the connection screw can shift vertically and/or horizontally in the hole during the erection process.

Therefore, it must be ensured that the lifting means is securely fastened. For this purpose, very high torques of up to approx. 1700 Nm must be applied while fastening the lifting means.

EP 2 035 316 B1 shows a lifting means with an eccentrically adjustable fastening point. In this way, the lifting means can be adjusted to different geometries of the components to be lifted. However, the lifting means has a complicated shape.

On the European patent application from which priority is claimed the European Patent Office searched the following documents: WO 2014/154220 A1, US 2011/194896 A1, U.S. Pat. No. 8,678,455 B2, U.S. Pat. No. 8,596,700 B2, U.S. Pat. No. 7,210,882 B2 and WO 2011/131254 A2.

### BRIEF SUMMARY

Some embodiments resolve one of the described problems. In particular, a lifting means is to be proposed that permits an attachment with a low torque by comparison to prior art. At the very least, an alternative is to be proposed. In particular, a simplified lifting means that can be adjusted to various components of wind turbines.

Some embodiments provide a wind turbine component lifting means.

Thus provided is a wind turbine component lifting means for lifting a component of a wind turbine. The lifting means has a main body with a first and second end, as well as a respective first fastening section for accommodating screws in the area of the first and second end. The first fastening section has an oblong hole along a longitudinal direction of the main body. Further provided is a floor plate unit, which has a floor plate with a borehole for accommodating at least one screw, wherein the borehole can be moved transverse to the longitudinal direction.

According to another aspect, the floor plate unit has two brackets, wherein the floor plate can be fastened to the main body by means of the two brackets. The floor plate can be designed so that it can be moved between the two brackets by means of screws or threaded rods.

According to another aspect, the lifting means has a lifting range between the first and second end of the main body. A sleeve can be provided in or on the lifting area, which is provided for accommodating a rope or a round sling for lifting the lifting means.

According to another aspect, the sleeve can have a two-part design, and have a respective first and second end as well as a middle section. The middle section can be cylindrical or semicylindrical in design.

In this application, indeterminate articles are to be understood as nonconclusive. For example, a first and a second fastening section always involve at least a first and at least a second fastening section.

Additional embodiments are the subject matter of the subclaims.

### BRIEF DESCRIPTION OF THE SEVERAL VIEWS OF THE DRAWINGS

Advantages and exemplary embodiments of the invention will be explained in more detail below with reference to the drawing.

FIG. 1 shows a schematic illustration of a wind turbine,

FIG. 2 shows an exploded illustration of a lifting means for lifting components of a wind turbine,

FIG. 3 shows another exploded illustration of a lifting means for lifting components of a wind turbine,

FIG. 4 shows a perspective sectional view of a lifting means,

FIG. 5 shows another perspective sectional view of a lifting means,

FIG. 6 shows a top view of a lifting means for lifting components of a wind turbine,

FIG. 7 shows a perspective view of a lifting means for lifting components of a wind turbine,

FIG. 8 shows a top view of an underside of a lifting means for lifting components of a wind turbine,

FIG. 9 shows a schematic illustration of a tower segment with two lifting means units,

FIG. 10 shows a schematic illustration of a tower segment with two lifting means units,

FIG. 11 shows a lifting means from prior art,

FIG. 12-20 show various embodiments of the lifting means,

FIG. 21 shows two mounted lifting means units on a tower segment of a wind turbine,

FIG. 22 shows directions of loads placed on the lifting means, and

FIG. 23 shows the force acting on the wedge-shaped fastening element.

### DETAILED DESCRIPTION

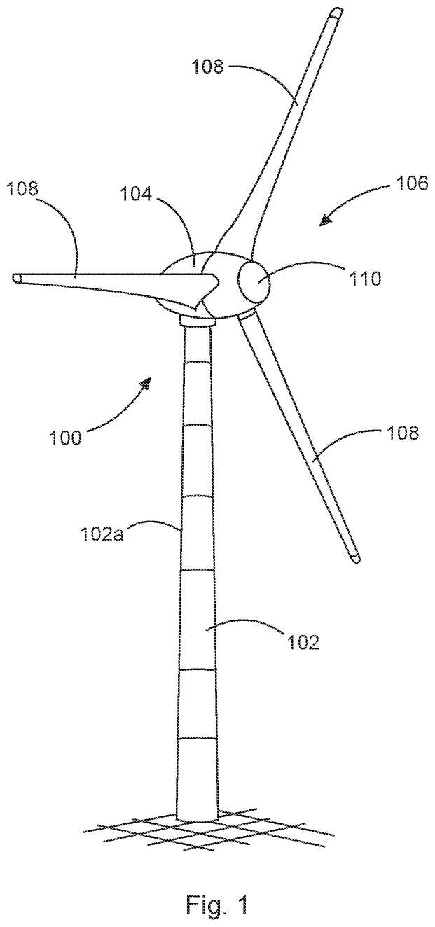

FIG. 1 shows a schematic illustration of a wind turbine. The wind turbine 100 has a tower 102 and a nacelle 104 on the tower 102. An aerodynamic rotor 106 with three rotor blades 108 and a spinner 110 is provided on the nacelle 104. During operation of the wind turbine, the aerodynamic rotor is made to rotate by the wind, and thus also turns a rotor or runner of a generator, which is directly or indirectly coupled with the aerodynamic rotor 106. The electric generator is arranged in the nacelle 104, and generates electric energy. The pitch angles of the rotor blades 108 can be changed by pitch motors on the rotor blade roots of the respective rotor blades 108. The tower 102 has a plurality of tower segments 102a. During assembly of the rotor of the wind turbine, these tower segments are placed one on top of the other in order to form the tower 102.

If the tower is conically shaped, this means that tower segments with varying diameters are present. Among other things, this causes the distance between holes in a flange of the tower segment to also depend on the size of the tower segment. In other words, the holes in the flanges of a lower tower segment can lie farther apart than holes in a flange of an upper tower segment.

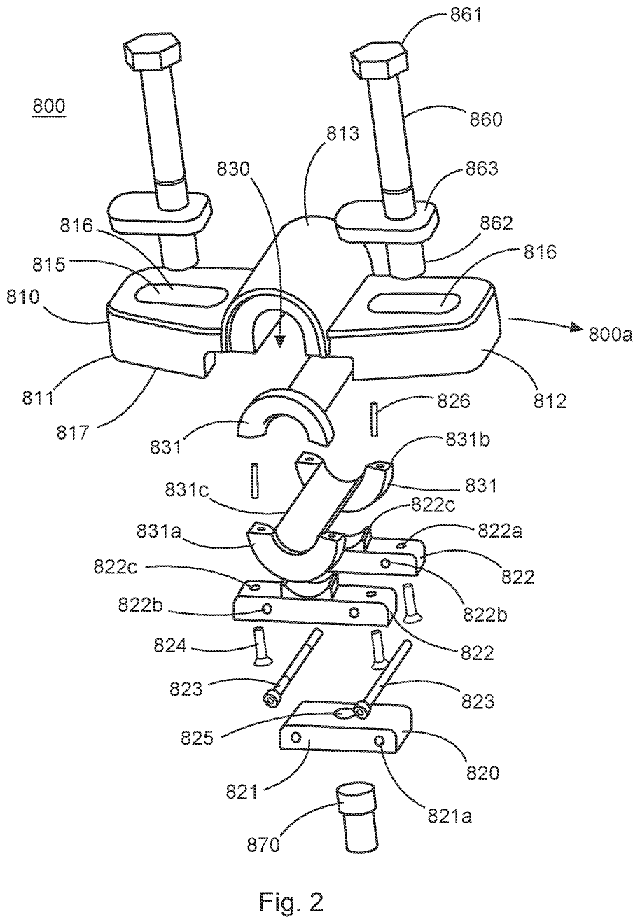

FIG. 2 shows an exploded illustration of a lifting means for lifting components of a wind turbine. A lifting means 800 is provided, for example so as to use the lifting means to be able to lift a tower segment of a wind turbine by means of a crane. The lifting means is here fastened to a tower segment, in particular to a flange of the tower segment, and a rope or a round sling can be fastened to the opposite side of the lifting means so that the tower segment can be lifted by means of a crane.

The lifting means 800 has a main body 810 with a first and second end 811, 812 and a middle section 813 along with a longitudinal direction 800a. A respective fastening element 815 is provided in the area of the first and second end 811, 812. This fastening element is used to be able to connect the lifting means 800 with a component of a wind turbine, e.g., by means of screws 860. For example, the fastening element 815 can have an oblong hole 816 or a slit in the longitudinal direction 800a. Due to the oblong hole configuration, the lifting means 800 can be moved in the longitudinal direction, or the positions of the screws 860 can be varied. The main body 810 further has a lower side or a floor 817. A lifting area 830 is provided in the area of the middle section 813, and used to accommodate a rope or a round sling

A sleeve 831 is optionally provided in the lifting area 830. The sleeve 831 can have a two-piece design. Each part of the sleeve has a first end 831a, a second end 831b and a middle section 831c. The middle section 831c can essentially be cylindrical or semicylindrical in design. The first and second ends 831a, 831b can each have a collar. A transition having no sharp edges can be provided inside of the collar between the collar area and the middle area. The configuration of the collar makes it possible to prevent damage to a cable or a round sling, which are passed through the sleeve so as to be able to lift the lifting means.

As an option, the cable sleeve 831 need also not be used, so that the rope or the round sling can be provided directly in the lifting area 830. The lifting area 830 essentially extends in the middle section 813 and transverse to the longitudinal direction. As an option, the lifting area 830 is provided as a hollow cylindrical or semi-hollow cylindrical recess in the main body 810. The alignment of this recess can be configured perpendicular to the longitudinal direction of the oblong holes 816.

The lifting means 800 further has a floor plate unit 820. The floor plate unit 820 has a floor plate 821 with a borehole 825, which is used to accommodate a screw or a screwed-in pin 870 for fastening and/or positioning the lifting means 800 in or on the component of the wind turbine.

The screw 870 can change its position transverse to the longitudinal direction. For this purpose, the floor plate can be displaceable, or the screw can be shifted in an oblong hole transverse to the longitudinal direction. The screw can also be configured as a bolt or rod.

In a concept with two wedges, the latter must be screwed in (at the end, the anchor point is fastened with three bolts on the flange); the middle need not be screwed in given a concept with an adjusting screw. Only a rod (replaceable rod depending on hole size) is necessary.

The floor plate 821 has two additional boreholes 821, which extend between the end faces of the floor plate 820, and thus optionally perpendicular to the borehole 825. The floor plate unit 820 further has two brackets 822, which each have two boreholes 822b on their end faces. The brakes further have two additional boreholes 822c. In addition, the brackets 822 each have a projection in the middle area, which is used to accommodate and hold the sleeve or a part of the sleeve 831. The two brackets 822 can be screwed to the underside 817 of the main body 810 by means of screws 824. The screws, in particular the threaded screws 823, are used for screwing the floor plate 821 between the two brackets 822. The position of the floor plate 821 between the two brackets 822 can be varied by activating the threaded screws 823. As a result, a variation can be achieved in the position of the borehole 825 in the longitudinal direction of the sleeve 831. Furthermore, the position of the floor plate 820, and thus of the borehole 825, perpendicular to the longitudinal direction of the oblong holes 816 can optionally be changed. As an option, two screws can be provided to hold the plate 820 in position. Only one of them requires a thread. The second screw can serve as a guide. This is advantageous, since an adjustment with two screws need not be performed. The screws 823 can also be configured as a guide rod or bolt that can be adjusted by hand.

The lifting means can thus adjust to varying distances between boreholes of a flange of a tower segment in a longitudinal direction of the main body or transverse to the longitudinal direction 800a.

Screws 860 with a first and second end 861, 862 and a washer 863 can be provided in the oblong holes 816. The second ends 862 are here placed in the oblong holes 816. For example, the first end 861 can be configured as a screw head. The second ends 862 are thus guided through the oblong holes and boreholes in a tower flange, and can be fastened by means of a screw. Because the first fastening sections 815 are configured as oblong holes, the screws 860 guided through the oblong holes can be spaced a varying distance apart from each other, so that they can be adjusted to the distances of the passage boreholes of tower flanges of tower segments.

In addition to the above, the displaceable floor plate 820 as well as the passage borehole 825 in the floor plate 821 into which a screw or threaded rod is inserted can be used to set the position of this threaded rod relative to the position of the oblong holes. The threaded rod or the screw or the pin 870 can optionally be fastened in or on the passage borehole 825, for example by means of a nut. As an alternative thereto, the passage borehole 825 can have a thread into which are screwed various pins adjusted to the respective diameter of the borehole in the tower flange.

The other end is passed through the passage boreholes on the tower flanges of the tower segments, and can likewise be fastened by means of a nut, for example.

Thus obtained is a lifting means 800 which can be adjusted in two directions (in the longitudinal direction and transverse to the longitudinal direction) to varying distances between passage boreholes in a tower flange of a tower segment.

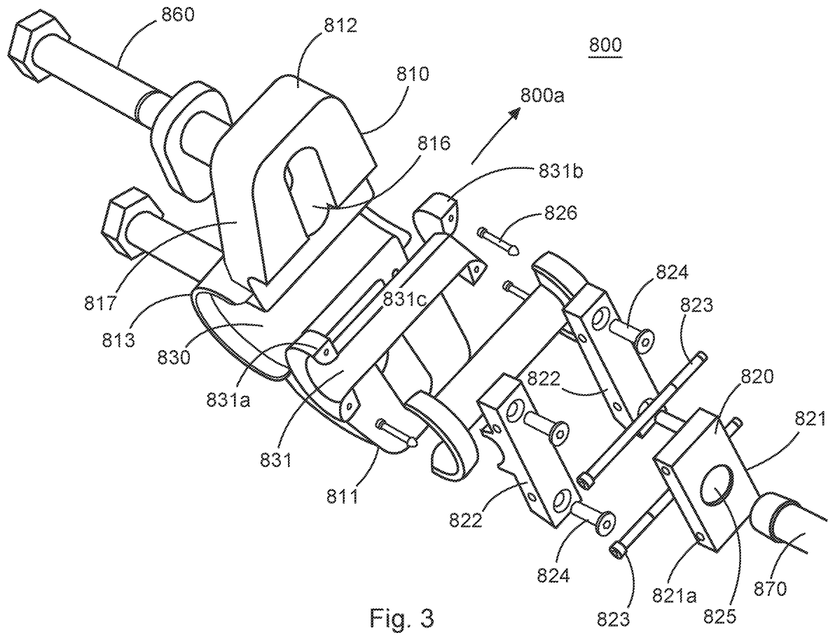

FIG. 3 shows another exploded illustration of a lifting means for lifting a component of a wind turbine. FIG. 3 shows a perspective, exploded illustration of the lifting means 800. The lifting means 800 has a main body 810 with a first and second end 811, 812, as well as a middle section 813 and a longitudinal direction 800a. Provided at the first and second ends 811, 812 is a respective fastening section 815, for example in the form of an oblong hole 816 or a slit (in the longitudinal direction 800a). A lifting area 830 can be provided in the area of the middle section 830. A sleeve 831 can optionally be placed in the lifting area 830. The sleeve 831 can be two-part in design. The sleeves 831 can have a first and second end 831a, 831b as well as a middle section 831c. The sleeves 831 are used to accommodate a rope, a cable or a round sling joint used for lifting the lifting means.

The lifting means 800 further has a floor plate unit 820 with a floor plate 821. The middle of the floor plate 821 has a passage borehole 825 for accommodating a screw 870. The floor plate 821 further has additional holes 821a. In addition, the floor plate unit 800 has two brackets 822. The floor plate 821 can be moved back and forth between the brackets 822 by means of screws, guide rods or threaded rods 823, so that the position of the passage borehole 825 thus also changes.

Due to the configuration of the fastening unit in the form of oblong holes and the floor plate unit that allows the floor plate 821 to be moved between the brackets 822, the lifting means can be adjusted to varying distances between passage boreholes of tower flanges of a tower segment.

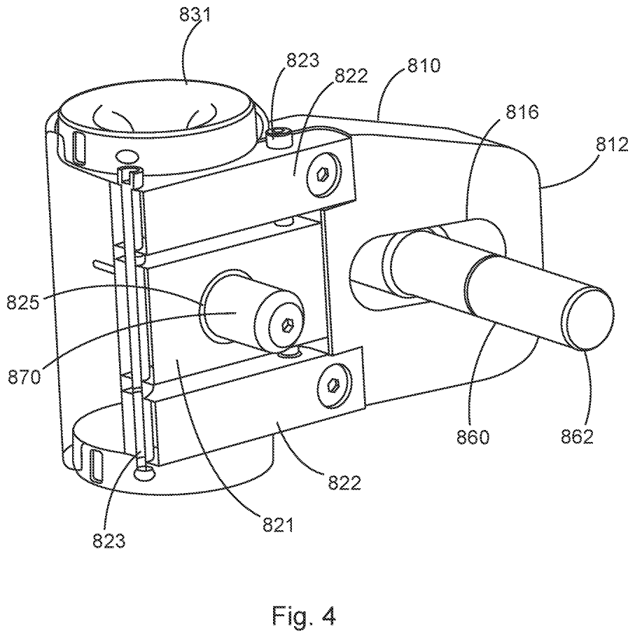

FIG. 4 shows a perspective, sectional view of a lifting means, for example from FIG. 2 or 3. FIG. 4 depicts the main body 810 of the lifting means 800 with its second end 812 with an oblong hole 816. A screw 860 can be placed in the oblong hole 816 and shifted back and forth along the length of the oblong hole 816. Furthermore, the sleeve 831 and the floor plate unit 820 are provided with the floor plate 821 and the brackets 822. The floor plate 821 can be moved back and forth along the threaded rods by means of the threaded screws or rods 823. As a result, a screw 870 placed in the passage borehole 825 in the floor plate 821 can be moved back and forth. The movement of the screw can here be essentially perpendicular to a screw 860 that is moved along the oblong hole 816.

FIG. 5 shows another perspective, sectional view of a lifting means.

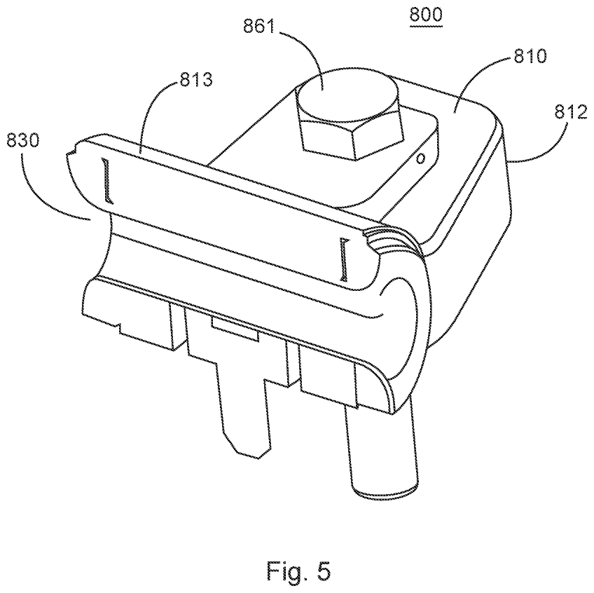

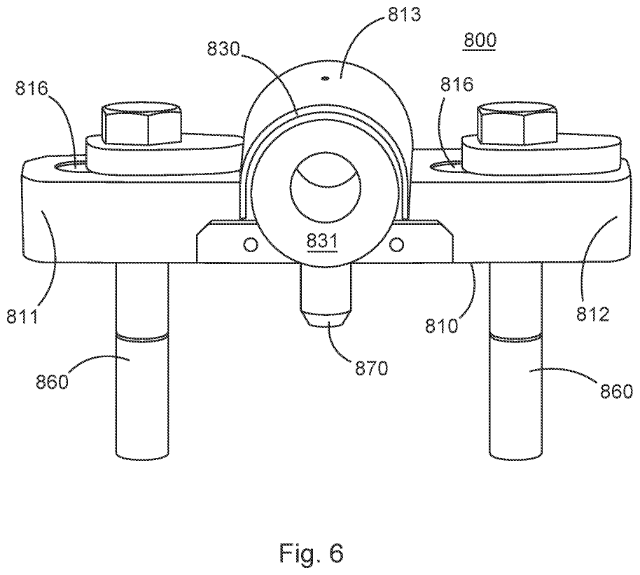

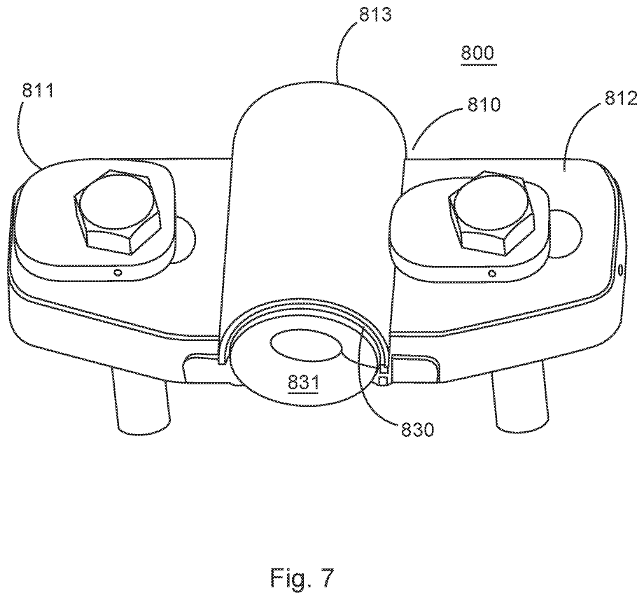

FIGS. 6 and 7 each show a perspective view of a lifting means. The lifting means 800 has a main body 810 with a first and second end 811, 812, which each have a fastening section 815. The fastening sections 815 each have an oblong hole 816 for accommodating fastening screws. A lifting area is provided in a middle section 813 between the first and second ends 811, 812 of the main body 810. A sleeve 831 can be provided in this lifting area 830.

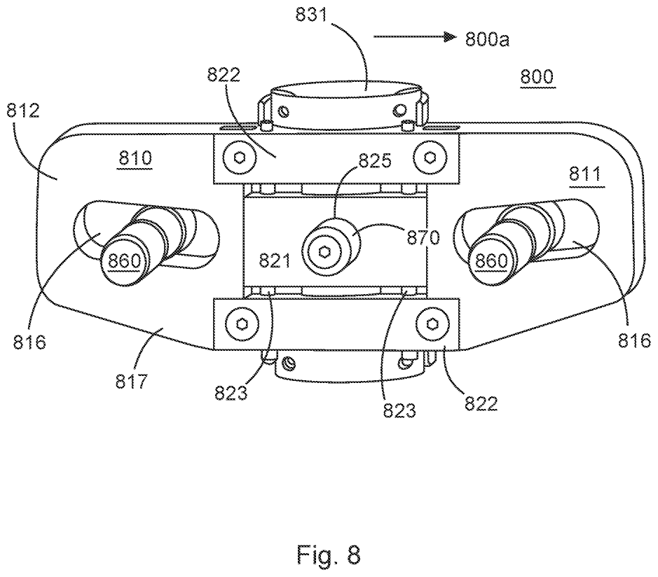

FIG. 8 shows a top view of an underside of a lifting means for lifting components of a wind turbine. FIG. 8 shows the lifting means 800 with a main body 810 with a first and second end 811, 812 and a middle section 813, as well as a longitudinal direction 800a. An oblong hole 816 is provided at the first and second ends 811, 812, and used to accommodate the screws 860. Two brackets 822 are provided in a lifting area 830, in particular in the floor 817 of the main body, along with a floor plate 821 between the brackets. The brackets and the floor plate are connected with each other via threaded rods or guide rods 823 in such a way that the floor plate 821 can be moved along the threaded rods by activating the threaded rods. The floor plate 821 has a passage borehole 825, which serves to accommodate a screw 870.

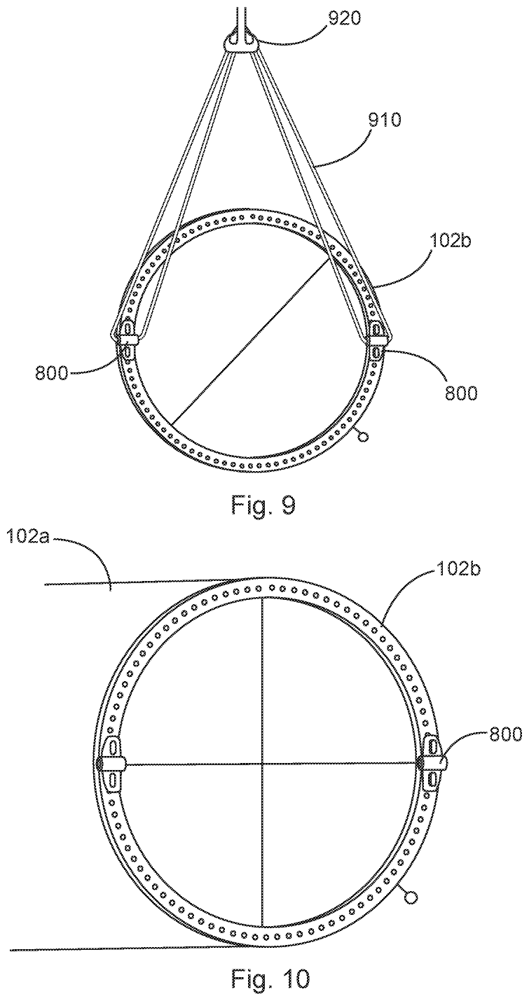

FIG. 9 shows a schematic illustration of a tower flange 102b, which can be fastened to a tower segment 102a. Two lifting means 800 can be fastened in the passage boreholes of the flange 102b by means of corresponding screws. Ropes, chains, or round slings 910 can be used to connect a crane hook 920 with the flange. The flange can thus be lifted with the lifting means.

FIG. 10 shows a mounted flange 102b. Two lifting means 800 can be fastened to the flange 102b, and can be used to lift the tower segment 102a.

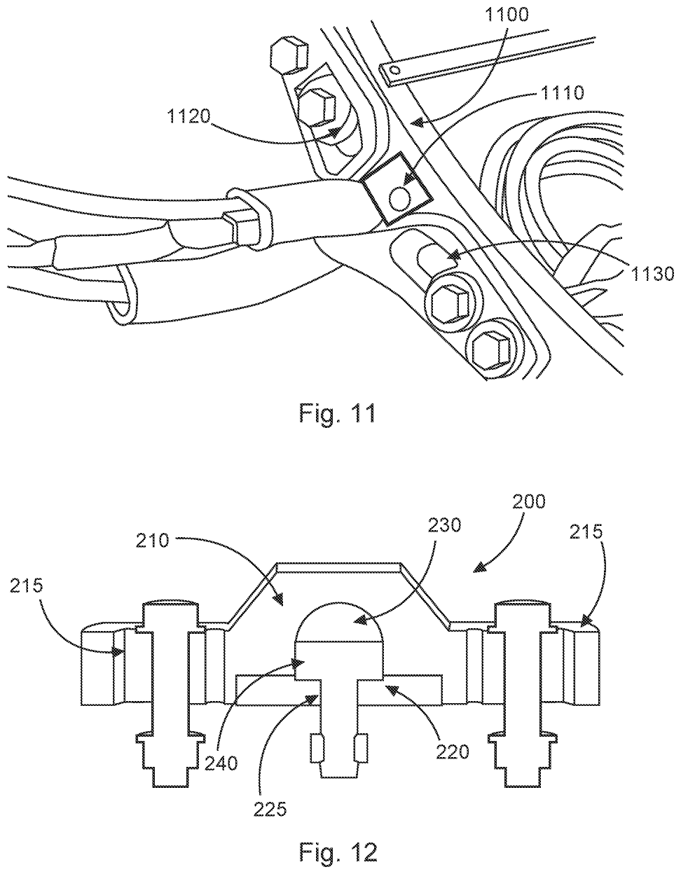

FIG. 11 shows a lifting means 1100 from prior art. The lifting means has a lifting area 1110, i.e., an opening, for fastening a rope for lifting with a crane. It likewise has a fastening area 1120, 1130 with a slit 1120 and a slit 1130, with which the lifting means 110 is connected with a tower segment of a wind turbine via screws.

However, enormous torques of approx. 1700 Nm are required for securing the lifting means 1100, so that the lifting means is reliably fastened.

FIG. 12 shows a longitudinal section through a lifting means. The lifting means 200 has a main body 210, a floor plate and a lifting area 230. The main body 210 has a first fastening section 215 with two slits or oblong holes, which can be used to fasten the lifting means 200 to a component of the wind turbine with screws. In addition, the floor plate 220 of the lifting means 200 has a second fastening area 225, as well as a wedge-shaped fastening element 240.

The main body 210 has a recess for accommodating the floor plate 220. The fastening element 240 can be provided above the floor plate 220 and in the area of the lifting area 230.

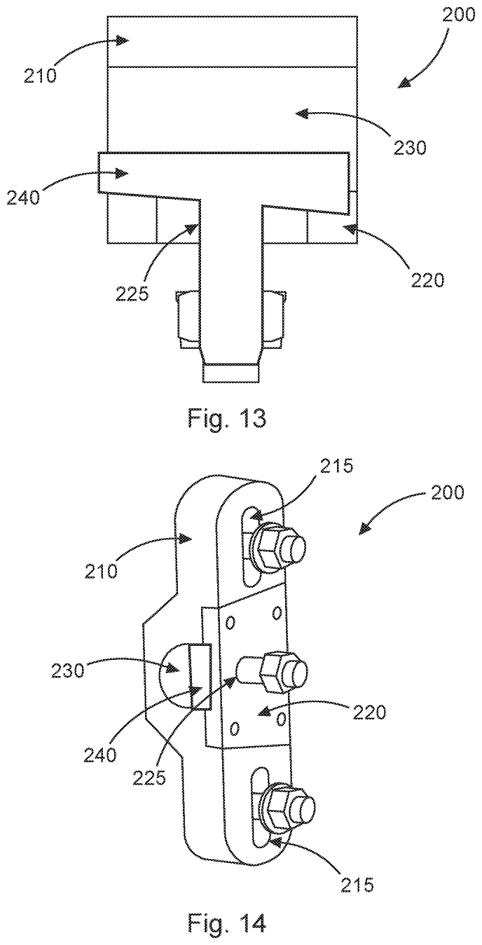

FIG. 13 shows a cross section of the lifting means on FIG. 2. The lifting means 200 has a main body 210, a floor plate 220 and a lifting area 230. The floor plate 220 is provided in the lower area of the main body 210 in a recess 211 in the main body 210. A fastening element 240 which has an upper wedge-shaped end is provided between the lifting area 230 and the floor plate 220.

FIG. 14 shows a perspective view of the lifting means on FIG. 12. Both the fastening element 240 and the floor plate 220 can be wedge-shaped or trapezoidal in design. The recess 211 in the main body provided for accommodating the floor plate 220 can be trapezoidal or wedge-shaped in design, so that a floor plate with a trapezoidal or wedge-shaped design can be used. The floor plate 220 can be wedge-shaped or trapezoidal in design in its longitudinal alignment.

This cross section allows for a better view of the wedge-shaped element 240.

The floor plate 220 is exchangeable, and screwed to the underside of the lifting means 200 directed toward the component with four screws. This makes it easy to insert the fastening element 240 before the floor plate 220 is screwed to the main body 210.

The trapezoidal floor plate 220 rests in a recess in the main body 210 which is shaped like a trapezoid to the same extent. The lifting means is secured to the component of the wind turbine in such a way that that the load is directed in the direction of the tapering of the floor plate 220. As a result, the contact pressure is increased under a load.

The fastening element 240 is likewise wedge-shaped, and the lifting means 200 is directed in such a way as to align the tapering opposite a direction of the load. On FIG. 14, the fastening element 240 thus tapers toward the declining side. As a consequence, the contact pressure between the lifting means 200 and component of the wind turbine increases when a load is placed on the lifting means 200.

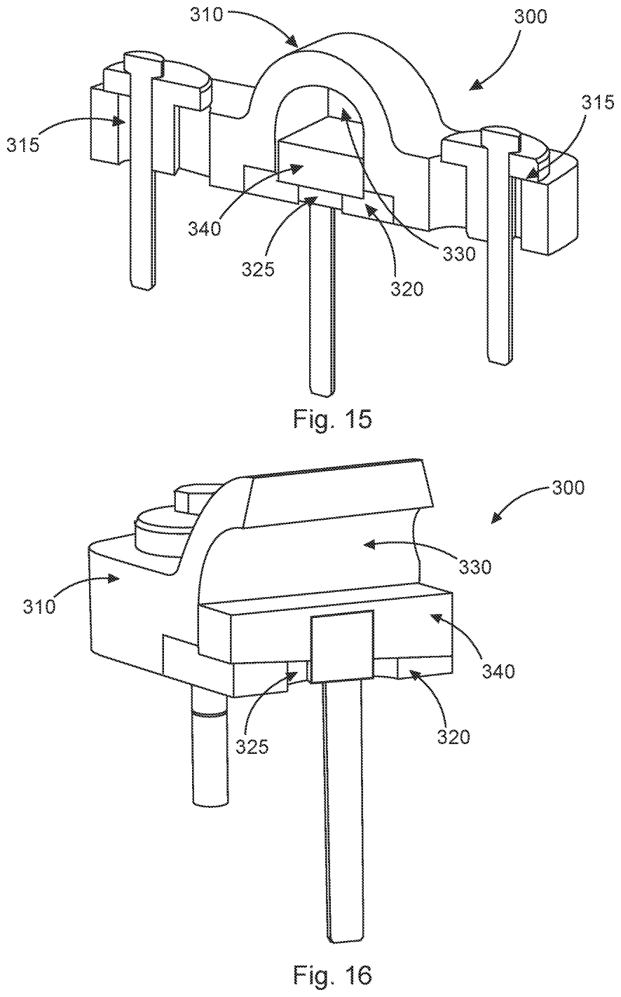

FIG. 15 shows a longitudinal section through another embodiment of a lifting means 300 with a main body 310 and floor plate 320. The main body has a first fastening area 315 with two slits. The floor plate has a second fastening area 325 with one slit.

FIG. 16 shows another section through the lifting means 300 on FIG. 15. As evident from FIG. 16, the fastening element 340 is wedge-shaped. The floor plate 320 is equally wedge-shaped in design. The connecting screw thus again lies on a planar surface.

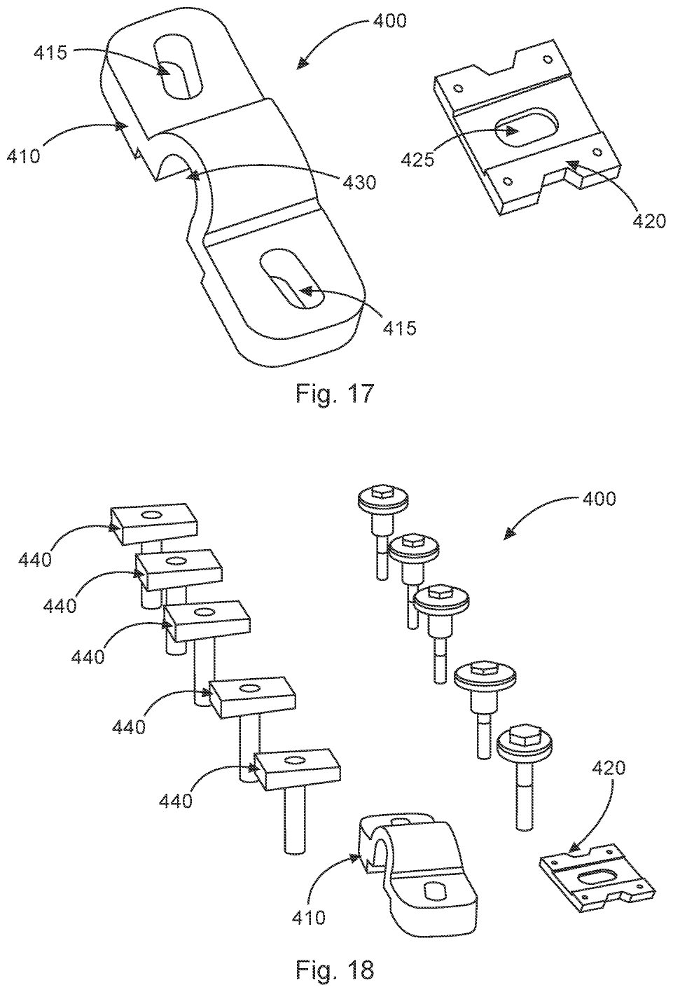

FIG. 17 shows another embodiment of a lifting means 400. The main body 410 and floor plate 420 are here shown in the unconnected state. For assembly purposes, the floor plate 420 is screwed to the underside, i.e., the side facing the component of the wind turbine, of the main body 410. The floor plate is then centrally arranged in the lifting means 400, below the lifting area 430.

The two slits 415a of a first fastening section 415 in the main body 410 are arranged at approximately a right angle to the slit 425a of a second fastening section 425 in the floor plate 420. As a consequence, the arrangement of the slits 415a, 425a in the first and second fastening sections 415, 425 block each other. This prevents the lifting means from shifting horizontally and/or vertically when lifting the component.

Furthermore, the two slits 415a of the first fastening section 415 cannot be aligned parallel. The advantage to this is that the lifting means 400 can be easily adjusted to different sizes of wind turbine components.

The floor plate 420 can have a wedge-shaped design in sections. It forms the counter-piece for a wedge-shaped fastening element 440. The wedge-shaped fastening element 440 and the floor plate 420 pull together more tightly when exposed to a load. As a result, only a slight tightening torque is required during assembly.

FIG. 18 shows another view of the lifting means 400 on FIG. 17. Additionally shown here are several replaceable fastening elements 440, along with accompanying screws.

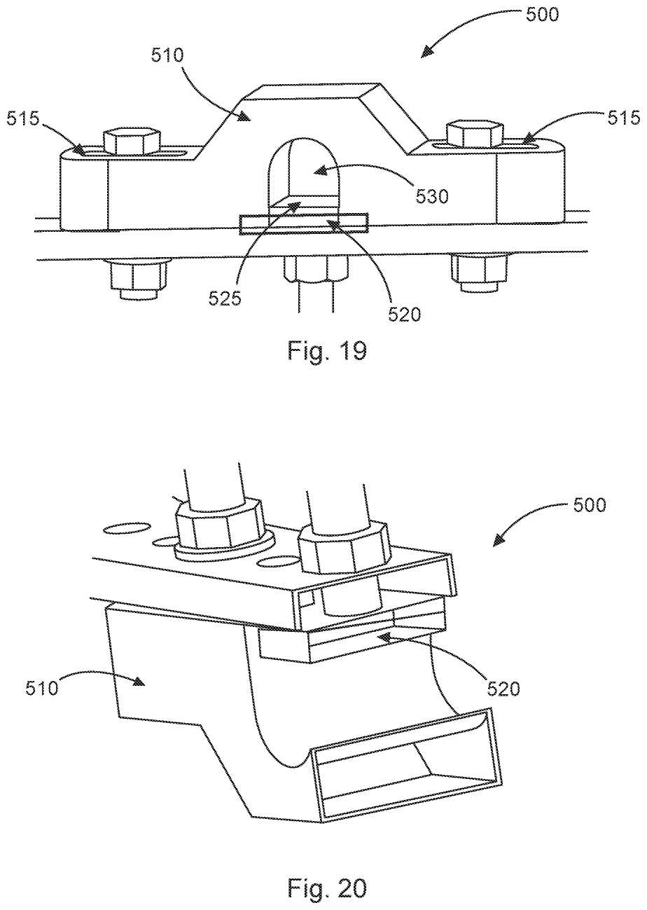

FIG. 19 shows another embodiment of a lifting means 500. A main body 510 here has a first fastening section 515, designed as two slits 515a through which the screws are guided in order to connect the main body 510 with the component of the wind turbine.

The main body 510 has a lifting area 530, through which a rope can be guided, on which the lifting means can be lifted with a crane.

Furthermore, the lifting means 500 has a floor plate 520, which is centrally arranged in the lifting means 500. The floor plate 520 is connected with the component of the wind turbine with a screw.

The wedge-shaped floor plate 520 is denoted by a square, which illustrates the rear, flat side of the floor plate 520.

FIG. 20 shows a section through the lifting means 500 on FIG. 19, in which the wedge-shaped floor plate 520 is denoted. On the one hand, the floor plate 520 itself can here comprise the wedge-shaped fastening element. In this case, the floor plate itself pulls tight between the main body 510 and the component of the wind turbine when exposed to a load. On the other hand, use can additionally be made of a wedge-shaped fastening element, which is placed on the wedge-shaped floor plate 520. In this preferred variant, the floor plate and fastening element pull each other tight, yielding a positive fit.

FIG. 21 shows two lifting means 600 fastened to a tower segment 650 of a wind turbine. Each lifting means 600 has guided through it a rope, with which a crane can lift the tower segment 650.

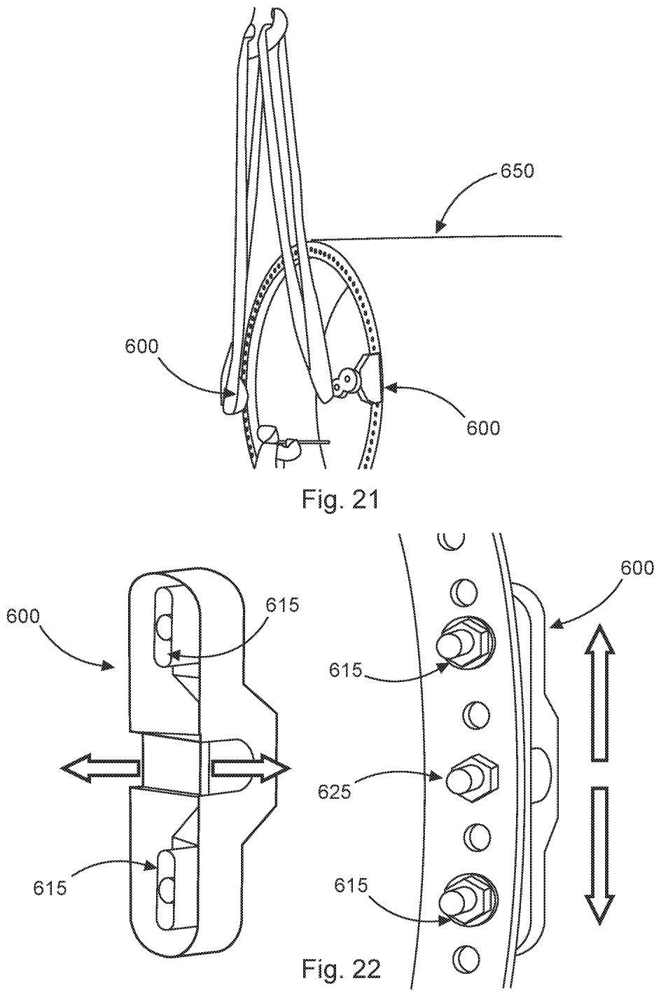

The lifting means 600 is here exposed to longitudinal and transverse loads. These load directions are denoted by arrows on FIG. 22. Because the slits in the first and second fastening sections 615, 625 are aligned at roughly a right angle to each other, a horizontal and/or vertical shifting of the screw connections in the slits is prevented.

As evident from FIG. 21, a component of the force acts in the direction of the cross sectional center of the tower segment owing to the arrangement of the lifting means on the tower segment.

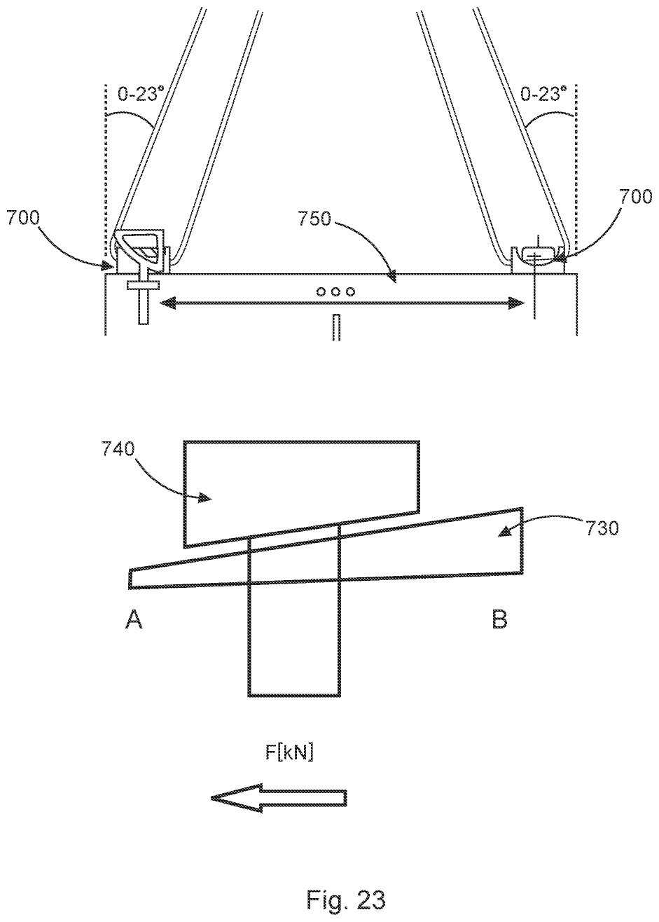

This is schematically illustrated once again on FIG. 23. In the upper image, two lifting means 700 are fastened to a tower segment of a wind turbine 750. Ropes are guided through the lifting means, so that a crane can lift the tower segment 750 with the ropes.

Therefore, a component of force acts in the direction of the cross sectional center of the tower segment 750. For the right lifting means 700, the horizontal component is schematically illustrated as a force arrow at the bottom of FIG. 13.

The right lifting means 700 then has a floor plate 730 and a fastening element 740, which are schematically shown on FIG. 13. The fastening element 740 is wedge-shaped in design. The floor plate 730 has a recess, so that a wedge-shaped surface likewise forms, on which the wedge-shaped fastening element 740 rests. The load acts on the lifting means 700, to which the floor plate 730 is fastened without much play. In this way, the lifting means 700 and floor plate 730 are pressed against the wedge-shaped fastening element 740. As a result, the contact pressure increases, and the lifting means tightens itself under a load. A slight tightening torque is thus required during assembly.

According to an aspect, a lifting means can be provided for lifting a component of a wind turbine. The lifting means has a main body with a first fastening section. The fastening section has an oblong hole. Furthermore, the lifting means comprises a floor plate with a second fastening section, e.g., in the form of a passage borehole for a fastening screw. The main body has a lifting area. The first and second fastening sections are provided to connect the lifting means with the component of the wind turbine. The second fastening section comprises a wedge-shaped fastening element.

For example, the lifting area in the main body is an opening, i.e., a hole in the main body or an eyelet. The lifting area can be configured like a recess. A rope can be guided through the lifting area, with which a crane can lift the lifting means.

The lifting means is secured to the component to be lifted via the first and second fastening sections. For this purpose, screws can be guided through a hole or a slit in the fastening section, and screw the lifting means with the component.

In the mounted state of the lifting means, the wedge-shaped fastening element can rest on the floor plate. In the second fastening section, the lifting means is secured to the component via the wedge-shaped fastening element. For example, this can be achieved by guiding a screw through the fastening element, the second fastening section in the floor plate and the component of the wind turbine, and then fixing it in place with a nut. It is likewise possible for the wedge-shaped fastening element to itself already be the head of a screw, which is guided through the second fastening section in the floor plate and the component of the wind turbine and fixed in place with a nut.

An advantage is that the lifting means tightens itself more when exposed to a load owing to the wedge-shaped fastening element. The force acting on the lifting means while lifting the component presses the wedge in the direction of the narrower end. The screw and nut are pressed apart by the wedge, and thus pull together more tightly.

As a result, the lifting means can be fastened to the component of the wind turbine with less torque, while still allowing for a reliable connection.

According to another aspect, the component of the wind turbine is a tower segment and/or a rotor blade and/or a rotor hub and/or another component of the wind turbine.

The lifting mean is then secured to the tower segment and/or the rotor blade, so as to lift or transport it. To this end, the tower segment and/or the rotor blade already have boreholes distributed over a periphery of a cross section. Screws or bolts are used to screw the lifting means on the first and second fastening areas with the holes in the tower segment and/or rotor blade.

According to another aspect, the wedge-shaped fastening element is aligned on the component of the wind turbine in such a way in the fastened state that it tapers opposite a direction of a tensile load.

When lifting the component, two respective lifting means are preferably secured to a side of the component. A rope is guided through both lifting means, and lifted by a crane. Therefore, a force then acts along the rope. The force here thus proportionally acts in the direction of the middle of the component.

The wedge-shaped fastening element is arranged so as to be tapered in the opposite direction. The load acts on the lifting means, thereby pulling the lifting means in the direction of the load. As a result, the wedge-shaped fastening element arranged directed opposite thereto is pressed against the floor plate. The wedge-shaped fastening element here presses apart the screw and nut used to secure the lifting means to the component of the wind turbine. This causes the lifting means to tighten itself. During assembly, this makes it possible to tighten the screws for fastening purposes with a reduced torque, less than 1700 Nm.

According to another aspect, the floor plate with the second fastening section is arranged in the middle of a base area of the lifting means.

The advantage achieved by fastening the lifting means at a point in the middle is that shear forces can be absorbed while erecting the component of the wind turbine.

According to another aspect, the first and second fastening sections each have a slit, and the slit of the first fastening section is aligned at roughly a right angle to the slit of the second fastening section.

The respective screw is guided through the slit, so as to connect the lifting means with the component.

The advantage to the slits is that the screws have a certain play. In this way, the lifting means can be fastened to different components. The component of the wind turbine to which the lifting means is fastened has holes spaced a certain distance apart from each other distributed over the periphery. In the lifting means, the screw can now be placed in the slit in such a way as to adjust itself to the distance in the component.

The problem here is that the screw could slip in the slit while lifting the component given the high forces that arise.

In order to avoid this, the slits of the first and second fastening sections are arranged at a relative angle to each other. However, even a slightly deviating angle would be suitable.

If the force acts along the slit of the first fastening section, the slit arranged at a right angle thereto blocks the movement along this direction in the second fastening section. Conversely, the slit behaves in the same way given a force along the slit of the second fastening section.

This prevents the lifting means from horizontally and/or vertically shifting while lifting the component.

According to another aspect, the floor plate is replaceable. The floor plate has a wedge and/or trapezoidal shape, wherein the wedge and/or trapezoidal shape yields a positive fit with the main body and/or the wedge-shaped fastening means of the second fastening section.

For example, the floor plate can be screwed to the underside of the lifting means directed toward the component with four screws.

The floor plate can here preferably centrally secured to the main body of the lifting means. For example, it can be arranged in such a way that the lifting area is located above the floor plate. This then has the additional advantage that the wedge-shaped fastening element and/or a screw for fastening purposes can only be guided through the second fastening section in the floor plate before the floor plate is connected to the main body. This makes the securing process easier, and also allows for the use of longer screws, which would otherwise be limited by a height of the opening of the lifting area.

The floor plate can likewise be wedge-shaped in its thickness or height, at least sectionally. To this end, for example, it can have a recess, wherein the recess is wedge-shaped. As a consequence, it can form the counter-piece to the wedge-shaped fastening element. The floor plate can become thicker where the wedge-shaped fastening element tapers, and vice versa.

As an advantageous result, the contact pressure is increased even further under a load. In addition, the screw head does not rest on a slope.

The counteraction between the two wedge-shaped parts causes the screw head itself to again rest on a flat plane. A one-sided load on the screw head and the screw is avoided.

Alternatively or additionally, the floor plate can also be wedge-shaped or trapezoidal to such an extent that yields the positive fit with the main body.

The surface of the floor plate can then not be rectangular, but rather trapezoidal. To this end, the main body can have a recess that is equally trapezoidal in shape. The floor plate can be placed in this recess. The wedge-shaped or trapezoidal surface can taper in the direction of an acting force. The force presses the floor plate into the recess in the main body, and a positive fit is achieved.

According to another aspect, the first fastening section has at least two slits, and the at least two slits are not aligned parallel to each other.

The slits of the first fastening section each lie at opposing ends of the main body. The floor plate with the second fastening section is centrally located between the slits of the first fastening section.

The two slits advantageously yield a better force distribution on the lifting means.

Another advantage is that the lifting means can be better secured to components with varying diameters via the slightly offset slits. Depending on the diameter of the components of the wind turbine, the screw in the slit is slightly displaced.

### LIST OF REFERENCE SIGNS

100 Wind turbine
102 Tower
102a Tower segments
102b Tower flange
104 Nacelle
106 Rotor
108 Rotor blades
108b Rotor blade roots
110 Spinner
120 Fastening area
130 Lifting area
200 Lifting means
210 Main body
211 Recess
215 Fastening section
216 Screws
220 Floor plate
225 Fastening area
230 Lifting area
240 Fastening element
241 Upper wedge-shaped end
242 Second
243 Screw
300 Lifting means
310 Main body
315 Fastening area
320 Floor plate
325 Fastening area
340 Fastening element
400 Lifting means
410 Main body
415 Fastening section
415a Slits
420 Floor plate
425 Fastening section
425a Slit
430 Lifting area
440 Fastening element
500 Lifting means
510 Main body
515 Fastening section
515a Slits
520 Floor plate
530 Lifting area
600 Lifting means
615 Fastening section
625 Fastening section
650 Tower segment
700 Lifting means
730 Floor plate
740 Fastening element
750 Wind turbine
800 Lifting means
800a Longitudinal direction
810 Main body
811 First end
812 Second end
813 Section
815 Fastening element
816 Oblong holes
817 Floor
820 Floor plate unit
821 Floor plate
821a Holes
822 Bracket
822b Boreholes
822c Boreholes
823 Threaded screws/bolts/rods
824 Screws
825 Borehole
830 Lifting area
831 Sleeve
831a First end
831b Second end
831c Middle section
850 Fastening unit
860 Screws
861 First end
862 Second end
863 Washer
870 Screw/pin
910 Round sling
920 Crane hook

European patent application no. 22214546.8, filed Dec. 19, 2022, to which this application claims priority, is hereby incorporated herein by reference, in its entirety. Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A wind turbine component lifting system for lifting a component of a wind turbine, comprising:
a main body with a first and second end, as well as a respective first fastening section for accommodating screws in the area of the first and second ends, wherein the first fastening section has an oblong hole along a longitudinal direction of the main body and
a floor plate unit, which has a floor plate with a borehole for accommodating at least one rod, screw, or a bolt, wherein the borehole can be moved transverse to the longitudinal direction,
wherein the floor plate unit has two brackets, wherein the floor plate can be fastened to the main body by the brackets,
wherein the floor plate can be moved between the two brackets by rods, screws, or threaded rods.

2. The wind turbine component lifting system according to claim 1, further comprising:
a lifting area between the first and second ends of the main body,
wherein a sleeve is provided in or on the lifting area, which is provided for accommodating a rope or a round sling for lifting the lifting system.

3. The wind turbine component lifting system according to claim 1, wherein the sleeve has a two-part design, and has a respective first and second end as well as a middle section, wherein the middle section is cylindrical or semicylindrical in design.

4. A wind turbine component lifting system for lifting a component of a wind turbine, comprising:
a main body with a first fastening section, and
a floor plate with a second fastening section,
wherein the main body has a lifting area,
wherein the first and second fastening sections are designed to connect the lifting system with the component of the wind turbine, and
wherein the second fastening section comprises a wedge-shaped fastening element,
wherein, in the fastened state of the lifting system to the component of the wind turbine, the wedge-shaped fastening element is aligned in such a way as to taper opposite a direction of a tensile load.

5. The lifting system according to claim 4, wherein the component of the wind turbine is a tower segment and/or a rotor blade of the wind turbine.

6. The lifting system according to claim 4, wherein the floor plate with the second fastening section is arranged in the middle of a base area of the lifting system.

7. The lifting system according to claim 4, wherein the first and second fastening sections each have a slit, and
the slit of the first fastening section is aligned at roughly a right angle to the slit of the second fastening section.

8. The lifting system according to claim 4, wherein the floor plate is replaceable, and
the floor plate has a wedge and/or trapezoidal shape, wherein the wedge and/or trapezoidal shape yields a positive fit with the main body and/or the wedge-shaped fastening element of the second fastening section.

9. The lifting system according to claim 4, wherein the first fastening section has at least two slits, and the at least two slits are not aligned parallel to each other.

10. A method for lifting a wind turbine component, comprising:
fastening a wind turbine component lifting system according to claim 4 to a wind turbine component, and
lifting the wind turbine component by the wind turbine component lifting system.
